(19) United States
(12) Patent Application Publication
(10) Pub. No.: US 2016/0316804 A1
(43) Pub. Date: Nov. 3, 2016

(54) SOL-GEL ENCAPSULATED WATER-SOLUBLE ORGANIC LIQUIDS AND ORGANIC LIQUIDS AND METHOD OF USING SAME

(71) Applicant: ABS MATERIALS, INC., Wooster, OH (US)

(72) Inventors: Paul L. EDMISTON, Wooster, OH (US); Stacey L. Dean, Broadview Heights, OH (US)

(21) Appl. No.: 15/089,384

(22) Filed: Apr. 1, 2016

Related U.S. Application Data
(60) Provisional application No. 62/141,603, filed on Apr. 1, 2015.

(51) Int. Cl. A23L 27/00; C12G 3/00; A23P 10/30

(52) U.S. Cl. CPC A23L 27/72; A23P 10/30; C12G 3/00; A23V 2002/00

(57) ABSTRACT

Disclosed is a composition of matter comprising a water-soluble organic liquid or water soluble liquid solution encapsulated by a porous sol-gel material and a method for releasing the water-soluble organic liquid or water soluble liquid solution from the porous sol-gel material.

### CROSS-REFERENCE TO RELATED APPLICATIONS

This application claims priority to U.S. Provisional Application Ser. No. 62/141,603, entitled SOL-GEL ENCAPSULATED WATER-SOLUBLE ORGANIC LIQUIDS AND ORGANIC LIQUIDS AND METHOD OF USING SAME, filed Apr. 1, 2015, which application is expressly incorporated by reference herein in its entirety.

### BACKGROUND

1. Field of the Invention

The present invention relates generally to the chemical arts. More particularly, the invention relates to encapsulated water-soluble organic liquids and encapsulated water-soluble organic liquid solutions, as well as methods for releasing the encapsulated water-soluble organic liquids and encapsulated water-soluble organic liquid solutions from the sol-gel material.

2. Discussion of Related Art

Water-soluble organic liquids and solutions containing water-soluble organic liquids have a variety of commercial, industrial and scientific uses. For example, ethanol and ethanolic solutions are the basis for alcoholic beverages. It can be a disadvantage of such liquids and solutions, which are often volatile, that they are difficult to preserve and store. For example, consumer-friendly, vapor and liquid tight packaging for alcoholic beverages are typically made of glass or plastic materials. Such materials are fragile and environmentally unfriendly. Consequently, there has been a long felt need for encapsulating water-soluble organic liquids and water-soluble organic liquid solutions, as well as simple and effective methods for releasing encapsulated water-soluble organic liquids and water-soluble organic liquid solutions when desired.

### SUMMARY OF THE INVENTION

Now in accordance with the invention there has been found a composition and a method providing for these needs as well as providing for additional advantages. In one aspect of the invention the composition comprises a water-soluble organic liquid or water soluble liquid solution encapsulated by a porous sol-gel material.

In one aspect, the sol-gel material has a pore volume of from about 0.9 mL/g to about 1.1 mL/g and, in one aspect, the sol-gel material has a pore volume of from about 0.2 mL/g to about 0.6 mL/g. In one aspect, the sol-gel material has a surface area of from about 300 m²/g to about 1300 m²/g and, in one aspect, the sol-gel material has a surface area of from about 600 m²/g to about 1000 m²/g. In one aspect, the sol-gel material is swellable to at least five times its original volume in acetone and, in one aspect, the sol-gel is swellable to about eight to ten times its original volume in acetone.

other aspect of the invention, the sol-gel material is obtained from

(a) from about 100 vol. % to about 10 vol. % at least one first alkoxysilane precursor having the formula:

(R′O)3-Si—(CH2)n-Ar—(CH2)m-Si—(OR′)3 (1)
where n and m are individually an integer from 1 to 8, Ar is a single-, fused-, or poly-aromatic ring, and each R′ is independently a C1 to C5 alkyl group and

(b) from about 0 vol. % to about 80 vol. % of at least one second precursor having the formula:

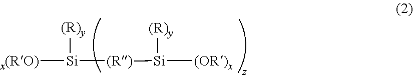

where x is 1, 2, 3 or 4; y is 0, 1, 2, 3; z is 0, 1; the total of x+y+z is 4; each R is independently an organic functional group; each an R′ is independently a C1 to C5 alkyl group and R″ is an organic bridging group. In one embodiment, x is 2 or 3, y is 1 or 2 and z is 0 and R′ is a methyl, an ethyl, or a propyl group.

In one embodiment, R comprises an unsubstituted or substituted straight-chain hydrocarbon group, branched-chain hydrocarbon group, cyclic hydrocarbon group, or aromatic hydrocarbon group and, in one embodiment, R comprises an alkyl hydrocarbon group, an aromatic hydrocarbon group, or an aromatic hydrocarbon group substituted with heteroatom containing moieties or aromatic amines. In one embodiment, the first alkoxysilane precursor comprises a bis(trialkoxysilylalkyl)benzene and, in one embodiment, the first alkoxysilane precursor comprises bis 1,4-bis(trimethoxysilylmethyl)benzene (BTB), bis(triethoxysilylethyl)benzene (BTEB), or mixtures thereof. In another embodiment, the second alkoxysilane precursor comprises tetramethoxysilane, methyltrimethoxysilane, methyltriethoxysilane, dimethyldimethoxysilane, dimethyldiethoxysilane, phenyltrimethoxysiliane, aminopropyl-trimethoxysilane, 1,4-bis(triethoxysilyl)benzene, 2-(trimethoxysilylethyl)pyridine, bis(triethoxysilylpropyl)amine, para-trifluoromethylterafluorophenyltrimethoxysilane, (tridecafluoro-1,1,2,2-tetrahydro-octyl)trimethoxysilane, 3-aminopropyltrimethoxysilane, 3-mercaptopropyltrimethoxysilane, 3-cyanopropyltrimethoxysilane, 3-sulfoxypropyltrimethoxysilane, isocyanopropyltrimethoxysilane, 2-(3,4-epoxycyclohexyl)ethyltrimethoxysilane, isocyanopropyltrimethoxysilane or trimethoxypropylbenzylcarbamate.

In one aspect, the amount of water-soluble organic liquid encapsulated by the porous sol-gel material is from about 150 to about 1100% w/w, in another aspect, the amount of water-soluble organic liquid encapsulated by the porous sol-gel material is from about 250 to about 950% w/w and, in still another aspect, the amount of water-soluble organic liquid or water soluble liquid solution encapsulated by the porous sol-gel material is from about 400 to about 700% w/w.

In another aspect, the water-soluble organic liquid or water soluble liquid solution further comprises a solute. In a further aspect, the solute is a flavor, fragrance or colorant. In one aspect, the solute is soluble in water at a concentration of at least 25 grams per liter, in one aspect, the solute is soluble in water at a concentration of at least 50 grams per liter and in one aspect, the solute is soluble in water at a concentration of at least 100 grams per liter.

In a further aspect, the water-soluble organic liquid is ethanol and in a still further aspect, the ethanol includes a solute. And in one aspect, the composition is contained in a water permeable receptacle.

In another aspect of the invention, a method for releasing a water-soluble organic liquid or water-soluble liquid solution comprises releasing a water-soluble organic liquid or water-soluble liquid solution encapsulating in a porous sol-gel material from the porous sol-gel material. And in one aspect, the porous sol-gel material encapsulated water-soluble organic liquid or water-soluble liquid solution is contained in a water permeable receptacle.

In one aspect of the invention, the porous sol-gel material encapsulated water-soluble organic liquid or water-soluble liquid solution is released by applying heat or a vacuum under conditions sufficient to release the porous sol-gel material encapsulated water-soluble organic liquid or water-soluble liquid solution from the porous sol-gel material. In another aspect of the invention, the porous sol-gel material encapsulated water-soluble organic liquid or water-soluble liquid solution is released by applying sufficient centrifugal force under conditions sufficient to release the porous sol-gel material encapsulated water-soluble organic liquid or water-soluble liquid solution from the porous sol-gel material. And in still another aspect of the invention, the porous sol-gel material encapsulated water-soluble organic liquid or water-soluble liquid solution is released by extracting with water or an aqueous solution under conditions sufficient to release the porous sol-gel material encapsulated from the porous sol-gel material.

In one aspect of the method, the sol-gel material has a pore volume of from about 0.9 mL/g to about 1.1 mL/g and, in one aspect, the sol-gel material has a pore volume of from about 0.2 mL/g to about 0.6 mL/g. In one aspect, the sol-gel material has a surface area of from about 300 m2/g to about 1300 m2/g and, in one aspect, the sol-gel material has a surface area of from about 600 m2/g to about 1000 m2/g. In one aspect, the sol-gel material is swellable to at least five times its original volume volume in acetone and, in one aspect, the sol-gel is swellable to about eight to ten times its original volume in acetone.

In other aspect of the inventive method, the sol-gel material is obtained from

(a) from about 100 vol. % to about 10 vol. % at least one first alkoxysilane precursor having the formula:

(R′O)3-Si—(CH2)n-Ar—(CH2)m-Si—(OR′)3 (1)
where n and m are individually an integer from 1 to 8, Ar is a single-, fused-, or poly-aromatic ring, and each R′ is independently a C1 to C5 alkyl group and

(b) from about 0 vol. % to about 80 vol. % of at least one second precursor having the formula:

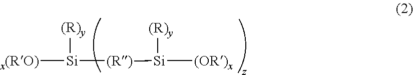

where x is 1, 2, 3 or 4; y is 0, 1, 2, 3; z is 0, 1; the total of x+y+z is 4; each R is independently an organic functional group; each an R′ is independently a C1 to C5 alkyl group and R″ is an organic bridging group. In one embodiment, x is 2 or 3, y is 1 or 2 and z is 0 and R′ is a methyl, an ethyl, or a propyl group.

In one embodiment of the method, R comprises an unsubstituted or substituted straight-chain hydrocarbon group, branched-chain hydrocarbon group, cyclic hydrocarbon group, or aromatic hydrocarbon group and, in one embodiment, R comprises an alkyl hydrocarbon group, an aromatic hydrocarbon group, or an aromatic hydrocarbon group substituted with heteroatom containing moieties or aromatic amines. In one embodiment, the first alkoxysilane precursor comprises a bis(trialkoxysilylalkyl)benzene and, in one embodiment, the first alkoxysilane precursor comprises bis 1,4-bis(trimethoxysilylmethyl)benzene (BTB), bis(triethoxysilylethyl)benzene (BTEB), or mixtures thereof. In another embodiment, the second alkoxysilane precursor comprises tetramethoxysilane, methyltrimethoxysilane, methyltriethoxysilane, dimethyldimethoxysilane, dimethyldiethoxysilane, phenyltrimethoxysiliane, aminopropyl-trimethoxysilane, 1,4-bis(triethoxysilyl)benzene, 2-(trimethoxysilylethyl)pyridine, bis(triethoxysilylpropyl)amine, para-trifluoromethylterafluorophenyltrimethoxysilane, (tridecafluoro-1,1,2,2-tetrahydro-octyl)trimethoxysilane, 3-aminopropyltrimethoxysilane, 3-mercaptopropyltrimethoxysilane, 3-cyanopropyltrimethoxysilane, 3-sulfoxypropyltrimethoxysilane, isocyanopropyltrimethoxysilane, 2-(3,4-epoxycyclohexyl)ethyltrimethoxysilane, isocyanopropyltrimethoxysilane or trimethoxypropylbenzylcarbamate.

In one aspect of the method, the amount of water-soluble organic liquid encapsulated by the porous sol-gel material is from about 150 to about 1100% w/w, in another aspect, the amount of water-soluble organic liquid encapsulated by the porous sol-gel material is from about 250 to about 950% w/w and in still another aspect, the amount of water-soluble organic liquid or water soluble liquid solution encapsulated by the porous sol-gel material is from about 400 to about 700% w/w.

In another aspect of the method, the water-soluble organic liquid or water soluble liquid solution further comprises a solute. In a further aspect, the solute is a flavor, fragrance or colorant and, in a further aspect. In one aspect, the solute is soluble in water at a concentration of at least 25 grams per liter, in one aspect, the solute is soluble in water at a concentration of at least 50 grams per liter and in one aspect, the solute is soluble in water at a concentration of at least 100 grams per liter.

In a further aspect, the water-soluble organic liquid is ethanol and in a still further aspect, the ethanol includes a solute.

### DETAILED DESCRIPTION OF THE PREFERRED EMBODIMENTS

Particular embodiments of the invention are described below in considerable detail for the purpose of illustrating its principles and operation. However, various modifications may be made, and the scope of the invention is not limited to the exemplary embodiments described below.

Unless otherwise described, all technical terms used herein have the same meaning as commonly understood by one of ordinary skill in the art to which the present invention pertains.

As used herein “solute” means any compound dissolved in a solvent.

As used herein “sorb” means to take up whether by adsorption, absorption, or a combination thereof.

In accordance with the invention, there has been discovered sol-gel encapsulated water-soluble organic liquids and sol-gel encapsulated water-soluble organic liquid solutions, as well as methods for releasing the encapsulated water-soluble organic liquids and water-soluble organic liquid solutions. In one aspect of the invention, the water-soluble organic liquids and water-soluble organic liquid solutions are encapsulated in a porous sol-gel material.

In one aspect, the porous sol-gel material is obtained from at least one first alkoxysilane precursor having the formula:

(R′O)₃-Si—(CH₂)ₙAr—(CH₂)ₘ-Si—(OR′)₃ (1)
where n and m are individually an integer from 1 to 8, Ar is a single-, fused-, or poly-aromatic ring, such as a phenyl or naphthyl ring, and each R is independently a C₁ to C₅ alkyl group, such as methyl or ethyl group.

Exemplary first alkoxysilane precursors include, without limitation, bis(trialkoxysilylalkyl)benzenes, such as 1,4-bis(trimethoxysilylmethyl)benzene (BTB), bis(triethoxysilylethyl)benzene (BTEB), and mixtures thereof, with bis(triethoxysilylethyl)benzene being preferred.

In another aspect, the porous sol-gel material is obtained from a mixture of the at least one first alkoxysilane precursor and at least one second alkoxysilane precursor, where the at least one second alkoxysilane precursor has the formula:

with 0-80% by weight of a second organosilica precursor having the structure:

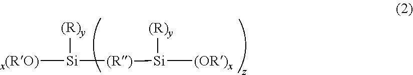

where x is 1, 2, 3 or 4; y is 0, 1, 2, 3; z is 0, 1; the total of x+y+z is 4 and, in some embodiments, where x is 2 or 3, y is 1 or 2 and z is 0 and the total of x+y+z is 4, R is independently an organic functional group; R′ is independently a C₁ to C₅ alkyl group, for example methyl, ethyl, or propyl groups; and R″ is an organic bridging group, for example an alkyl or aromatic bridging group.

In some embodiments, each R is independently an aliphatic or non-aliphatic hydrocarbon containing up to about 30 carbons, with or without one or more hetero atoms (e. g., sulfur, oxygen, nitrogen, phosphorous, and halogen atoms) or hetero atom-containing moieties. Representative R's include straight-chain hydrocarbons, branched-chain hydrocarbons, cyclic hydrocarbons, and aromatic hydrocarbons and are unsubstituted or substituted. In some aspects, R includes alkyl hydrocarbons, such as C₁-C₃ alkyls, and aromatic hydrocarbons, such as phenyl, and aromatic hydrocarbons substituted with heteroatom containing moieties, such —OH, —SH, —NH₂, and aromatic amines, such as pyridine.

Representative substituents for R include primary amines, such as aminopropyl, secondary amines, such as bis(triethoxysilylpropyl)amine, tertiary amines, thiols, such as mercaptopropyl, isocyanates, such as isocyanopropyl, carbamates, such as propylbenzylcarbamate, alcohols, alkenes, pyridine, halogens, halogenated hydrocarbons or combinations thereof. Exemplary second alkoxysilane precursors include, without limitation, tetramethoxysilane, methyltrimethoxysilane, methyltriethoxysilane, dimethyldimethoxysilane, dimethyldiethoxysilane, phenyltrimethoxysiliane, aminopropyl-trimethoxysilane, 1,4-bis(triethoxysilyl)benzene, 2-(trimethoxysilylethyl)pyridine, bis(triethoxysilylpropyl)amine, para-trifluoromethylterafluorophenyltrimethoxysilane, (tridecafluoro-1,1,2,2-tetrahydro-octyl)trimethoxysilane, 3-aminopropyltrimethoxysilane, 3-mercaptopropyltrimethoxysilane, 3-cyanopropyltrimethoxysilane, 3-sulfoxypropyltrimethoxysilane, isocyanopropyltrimethoxysilane, 2-(3,4-epoxycyclohexypethyltrimethoxysilane, isocyanopropyltrimethoxysilane and trimethoxypropylbenzylcarbamate.

In one aspect, the second alkoxysilane precursor is dimethyldimethoxysilane, dimethyldiethoxysilane, phenyltrimethoxysilane or aminopropyltriethoxysilane.

The porous sol-gel materials are obtained from an alkoxysilane precursor reaction medium, under acid or base sol-gel conditions, preferably base sol-gel conditions. In one aspect of the present invention, the alkoxysilane precursor reaction medium contains from about 100:00 vol:vol to about 10:90 vol:vol of the at least one first alkoxysilane precursor to the at least one second alkoxysilane precursor and, in one aspect, and from about 20:80 vol:vol to about 50:50 vol:vol first alkoxysilane precursor to second alkoxysilane precursor. In one aspect, the alkoxysilane precursor reaction medium contains 100% of the at least one first alkoxysilane precursor. The relative amounts of the at least one first alkoxysilane and the at least one second alkoxysilane precursors in the reaction medium will depend on the particular alkoxysilane precursors and the particular application for the resulting sol-gel material. The relative amounts will be readily determinable without undue experimentation.

The reaction medium includes a solvent for the alkoxysilane precursors. In some aspects, the solvent has a Dimoth-Reichart solvatochromism parameter (E_{T}) between 170-205 kJ/mol. Suitable solvents include, without limitation, tetrahydrofuran (THF), acetone, dichloromethane/THF mixtures containing at least 15% by vol. THF, and THF/acetonitrile mixtures containing at least 50% by vol. THF. Of these exemplary solvents, THF is preferred. The alkoxysilane precursors are preferably present in the reaction medium at between about 0.25M and about 1M, more preferably between about 0.4M and about 0.8M, most preferably about 0.5 M.

A catalytic solution comprising a catalyst and water is rapidly added to the reaction medium to catalyze the hydrolysis and condensation of the alkoxysilane precursors, so that a sol gel coating is formed on the particles. Conditions for sol-gel reactions are well-known in the art and include the use of acid or base catalysts. Preferred conditions are those that use a base catalyst. Exemplary base catalysts include, without limitation, tetrabutyl ammonium fluoride (TBAF), fluoride salts, including but not limited to potassium fluoride, 1,5-diazabicyclo[4.3.0]non-5-ene (DBN), and alkylamines, including but not limited to propyl amines, of which TBAF is preferred.

As noted above, acid catalysts can be used to form sol-gel coatings, although acid catalysts are less preferred. Exemplary acid catalysts include, without limitation, any strong acid such as hydrochloric acid, phosphoric acid, sulfuric acid and the like.

In one aspect, water is present in the reaction medium at an amount so there is at least one half mole of water per mole of alkoxysilane groups in the alkoxysilane precursors. In one aspect, temperatures at polymerization can range from between the freezing point of the reaction medium up to the boiling point of the reaction medium. And in one aspect, the temperature range is from about 4° C. to about 50° C.

After gelation, the sol-gel coating is preferably aged for an amount of time suitable to induce syneresis, which is the shrinkage of the gel that accompanies solvent evaporation. The aging drives off much, but not necessarily all, of the solvent. While aging times vary depending upon the catalyst and solvent used to form the gel, aging is typically carried out for about 15 minutes up to about 10 days. In one aspect, aging is carried out for at least about 1 hour and, in one aspect, aging is carried out for about 2 to about 10 days. In one aspect, aging temperatures can range from between the freezing point of the solvent or solvent mixture up to the boiling point of the solvent or solvent mixture. And in one aspect, the aging temperature is from about 4° C. to about 50° C. And in some aspects, aging is carried out either in open atmosphere, under reduced pressure, in a container or oven.

After gelation and aging have been completed, the sol-gel material is rinsed using an acidic solution, with solutions comprising stronger acids being more effective. In one aspect, the rinsing agent comprises concentrations between 0.009-0.2% w/v acid in an organic solvent. Representative organic solvents include solvents for the alkoxysilane precursors, including solvents having a Dimoth-Reichart solvatochromism parameter (ET) between 170-205 kJ/mol. Suitable solvents for use with the base catalysts include, without limitation, tetrahydrofuran (THF), acetone, dichloromethane/THF mixtures containing at least 15% by vol. THF, and THF/acetonitrile mixtures containing at least 50% by vol. THF. Preferred rinse reagents, include without limitation, 0.01% wt:vol HCl or 0.01% wt:vol H2SO4 in acetone. In one aspect, the sol-gel material is rinsed with the acidic solution for at least 5 min. And in one aspect, the sol-gel material is rinsed for a period of time of from about 0.5 hr. to about 12 hr.

An alternative rinsing method is to use a pseudo-solvent system, such as supercritical carbon dioxide.

In one aspect, the resulting sol-gel material contains a plurality of flexibly tethered and interconnected organosiloxane particles having diameters on the nanometer scale. The organosiloxane nanoparticles form a porous matrix defined by a plurality of aromatically cross-linked organosiloxanes that create a porous structure. In some aspects, the resulting sol-gel material has a pore volume of from about 0.9 mL/g to about 1.1 mL/g and, in some aspects, a pore volume of from about 0.2 mL/g to about 0.6 mL/g. In some aspects, the resulting sol-gel material has a surface area of from about 300 m²/g to about 1300 m²/g and, in some aspects, a surface area of from about 600 m²/g to about 1000 m²/g.

And one aspect, the resulting sol-gel material is hydrophobic, resistant to absorbing water, and swellable to at least two times its volume, when dry, in acetone. In one aspect, the sol-gel material is swellable to at least five times its original volume and, in one aspect, up to about eight to ten times their original volume in acetone. In one aspect, the sol-gel material sorbs at least 2.5 times its mass water-soluble organic liquids and water-soluble organic liquid solutions. Useful sol-gel materials include, but are not limited to, OSORB® media available from ABSMaterials, Wooster, Ohio.

It is a distinct advantage that the porous sol-gel material can be used to encapsulate a large number of water-soluble organic liquids and water-soluble organic liquid solutions. In one aspect, the water-soluble organic liquid is ethanol and the water-soluble organic liquid solutions are ethanolic solutions.

In one aspect, the water-soluble organic liquid or the water-soluble organic liquid solution can contain any suitable solute. Suitable solutes include, without limitation antiseptics, water-soluble organic liquid actives, and the like. In one aspect, the solute dissolves in water at a concentration of at least 25 grams per liter; in one aspect, the solute is soluble in water at a concentration of at least 50 grams per liter; and in one aspect, the solute is soluble in water at a concentration of at least 100 grams per liter. In one aspect the water-soluble organic liquid solution is a ethanolic solution and representative solutes include, without limitation, ethanol soluble flavors, fragrances, colorants and the like.

The water-soluble organic liquids and water-soluble organic liquid solutions can be encapsulated by any suitable method. In one aspect, the water-soluble organic liquids and water-soluble organic liquid solutions are encapsulated by contacting the porous sol-gel material with the water-soluble organic liquids and water-soluble organic liquid solutions under conditions sufficient to cause the porous sol-gel material to sorb the water-soluble organic liquids or water-soluble organic liquid solutions. It is a definite advantage of the inventive method that the water-soluble organic liquids and water-soluble organic liquid solutions can be sorbed by the porous sol-gel material at ambient temperature and pressure.

In one aspect, the amount of water-soluble organic liquid and water-soluble organic liquid solution encapsulated by the porous sol-gel material is from about 150 to about 1100% w/w. In a further aspect, the amount of water-soluble organic liquids and water-soluble organic liquid solutions encapsulated is from about 250 to about 950% w/w. And is a still further aspect, the amount of water-soluble organic liquids and water-soluble organic liquid solutions encapsulated is from about 400 to about 700% w/w.

In one aspect the resulting sol-gel encapsulated water-soluble organic liquids and sol-gel encapsulated water-soluble organic liquid solutions are packaged in a water and water-soluble organic liquids and water-soluble organic liquid solutions permeable receptacle including, without limitation, a teabag. Other packaging can include, but is not limited to, mesh lined cartridges, and plastic containers or cartridges with pores to allow water to permeate.

In accordance the inventive method, the water-soluble organic liquids and water-soluble organic liquid solutions are subsequently released from the porous sol-gel material. In one aspect, the water-soluble organic liquids or water-soluble organic liquid solutions are released by applying heat or a vacuum to the encapsulated material. In a further aspect, the water-soluble organic liquids or water-soluble organic liquid solutions are released using centrifugation. In a still further aspect, the water-soluble organic liquids or water-soluble organic liquid solutions are released by extraction using water or an aqueous solution.

It is another distinct advantage of the inventive method that the water-soluble organic liquids and water-soluble organic liquid solutions are delivered with a high delivery efficiency. In one aspect the delivery efficiency is greater than 90% w/w and in one aspect the delivery efficiency is greater than 95% w/w.

Upon extraction, representative products include, without limitation, alcoholic beverages, antiseptics and water-soluble organic liquid actives, such as ethanol soluble actives.

### EXAMPLE

Ethanol and ethanolic solutions were encapsulated in Osorb® sol-gel media and then released from the sorbent matrix using the following methods.

### Example 1

### (1) Encapsulation of Ethanol

1 g Osorb® sol-gel media is loaded with 4.1 mL 200 proof ethanol at room temperature by bringing the media and the ethanol in contact whereby the ethanol is absorbed into the media. The resulting product has the following characteristics:

Percent mass ethanol: 76% w/w

Loading: 4.1 mL ethanol/g Osorb (325% loading)

Appearance: Solid gel beads. Dry to the touch.

### (2) Release of Ethanol

A 40% v/v ethanol beverage is prepared by combining 100 g of the ethanol loaded Osorb media with 100 mL of water. The Osorb media and the water are then mixed together whereby the ethanol is released from the Osorb media and into the water creating an alcoholic beverage. During this process media was held in a teabag, to retain the media, so the alcoholic beverage is free of media particles.

### Example 2

### (1) Encapsulation of Ethanolic Solution

2 g Osorb® sol-gel media is loaded with 8.2 mL 200 proof ethanol containing 0.001% w/v FD&C Yellow No. 5 yellow dye. The Osorb media was loaded by bringing it in contact with the ethanolic solution in contact whereby the Osorb media sorbed the ethanolic solution.

Two grams of dry Osorb® sol-gel media was loaded with yellow food coloring and ethanol.

The encapsulated product had a 325% mass loading of the yellow dye dissolved in the ethanol in its pores, but was dry to the touch.

### (2) Release of Ethanolic Solution

A 3.6 g sample of the ethanol-yellow food coloring loaded Osorb® sol-gel media was loaded into a teabag. The teabag was then placed in 150 mL of clear ice water for extraction. Delivery of the ethanol-yellow food coloring solution took <30 s. The concentration of the ethanolic solution in the ice water was determined to be 1.78% w/w by headspace gas chromatography. The ethanol and food coloring was extracted out of the Osorb matrix into the ice water to make a 1.78% w/w ethanolic solution containing the yellow dye.

Based on the amount of ethanol-yellow food coloring encapsulated in the Osorb® sol-gel media loading the maximum theoretical concentration of the ethanolic solution was 1.87% w/w. Therefore, the actual 1.78% w/w concentration of the ethanolic solution corresponds to a 96% delivery efficiency.

From the above description of the invention, those skilled in the art will perceive improvements, changes and modifications. For example, one skilled in the art will appreciate that other agents and materials, such as charged organic polymers (e.g., polyethyleneimine) and/or organosilica nanoparticles having different surface chemistries can be included in the sensor material to facilitate detection of sorbates. Such improvements, changes, and modifications are within the skill of the art and are intended to be covered by the appended claims.

1. A composition of matter comprising
a water-soluble organic liquid or water soluble liquid solution encapsulated by a porous sol-gel material.

2. The composition of claim 1 wherein the sol-gel material has a pore volume of from about 0.9 mL/g to about 1.1 mL/g.

3. The composition of claim 2 wherein the sol-gel material has a pore volume of from about 0.2 mL/g to about 0.6 mL/g.

4. The composition of claim 1 wherein the sol-gel material has a surface area of from about 300 m²/g to about 1300 m²/g.

5. The composition of claim 4 wherein the sol-gel material has a surface area of from about 600 m²/g to about 1000 m²/g.

6. The composition of claim 1 wherein the sol-gel material is swellable to at least five times its original volume in acetone.

7. The composition of claim 6 wherein the sol-gel is swellable to about eight to ten times its original volume in acetone.

8. The composition of claim 8 wherein the sol-gel material is obtained from
(a) from about 100 vol. % to about 10 vol. % at least one first alkoxysilane precursor having the formula:
(R′O)₃-Si—(CH₂)ₙAr—(CH₂)ₘ-Si—(OR′)₃ (1)
where n and m are individually an integer from 1 to 8, Ar is a single-, fused-, or poly-aromatic ring, and each R′ is independently a C₁ to C₅ alkyl group and
(b) from about 0 vol. % to about 80 vol. % of at least one second precursor having the formula: 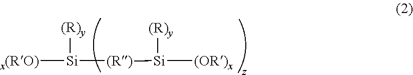
where x is 1, 2, 3 or 4; y is 0, 1, 2, 3; z is 0, 1; the total of x+y+z is 4; each R is independently an organic functional group; each an R′ is independently a C₁ to C₅ alkyl group and R″ is an organic bridging group.

9. The composition of claim 8 where x is 2 or 3, y is 1 or 2 and z is 0 and R′ is a methyl, an ethyl, or a propyl group.

10. The composition of claim 8 wherein R comprises an unsubstituted or substituted straight-chain hydrocarbon group, branched-chain hydrocarbon group, cyclic hydrocarbon group, or aromatic hydrocarbon group.

11. The composition of claim 10 wherein R comprises an alkyl hydrocarbon group, an aromatic hydrocarbon group, or an aromatic hydrocarbon group substituted with heteroatom containing moieties or aromatic amines.

12. The composition of claim 8 wherein the first alkoxysilane precursor comprises a bis(trialkoxysilylalkyl)benzene.

13. The composition of claim 12 where the first alkoxysilane precursor comprises bis 1,4-bis(trimethoxysilylmethyl)benzene (BTB), bis(triethoxysilylethyl)benzene (BTEB), or mixtures thereof.

14. The composition of claim 8 wherein the second alkoxysilane precursor comprises tetramethoxysilane, methyltrimethoxysilane, methyltriethoxysilane, dim ethyldimethoxysilane, dimethyldiethoxysilane, phenyltrimethoxysiliane, aminopropyl-trimethoxysilane, 1,4-bis(triethoxysilyl)benzene, 2-(trimethoxysilylethyl)pyridine, bis(triethoxysilylpropyl)amine, para-trifluoromethylterafluorophenyltrimethoxysilane, (tridecafluoro-1,1,2,2-tetrahydro-octyl)trimethoxysilane, 3-aminopropyltrimethoxysilane, 3-mercaptopropyltrimethoxysilane, 3-cyanopropyltrimethoxysilane, 3-sulfoxypropyltrimethoxysilane, isocyanopropyltrimethoxysilane, 2-(3,4-epoxycyclohexyl)ethyltrimethoxysilane, isocyanopropyltrimethoxysilane or trimethoxypropylbenzylcarbamate.

15. The composition of claim 1 wherein the amount of water-soluble organic liquid encapsulated by the porous sol-gel material is from about 150 to about 1100% w/w.

16. The composition of claim 15 wherein the amount of water-soluble organic liquid encapsulated by the porous sol-gel material is from about 250 to about 950% w/w.

17. The composition of claim 15 wherein the amount of water-soluble organic liquid or water soluble liquid solution encapsulated by the porous sol-gel material is from about 400 to about 700% w/w.

18. The composition of claim 1 wherein the water-soluble organic liquid or water soluble liquid solution further comprises a solute.

19. The composition of claim 18 wherein the solute is a flavor, fragrance or colorant.

20. The composition of claim 18 wherein the solute is soluble in water at a concentration of at least 25 grams per liter.

22. The composition of claim 18 wherein the solute is soluble in water at a concentration of at least 50 grams per liter.

22. The composition of claim 21 wherein the solute is soluble in water at a concentration of at least 100 grams per liter.

23. The composition of claim 1 wherein the water-soluble organic liquid is ethanol.

24. The composition of claim 23 further comprising a solute.

25. The composition of claim 1 further comprising a water permeable receptacle in which the composition is contained.

26. A method for releasing a water-soluble organic liquid or water-soluble liquid solution comprising:
releasing a water-soluble organic liquid or water-soluble liquid solution encapsulated in a porous sol-gel material from the porous sol-gel material.

27. The method of claim 26 wherein the porous sol-gel material encapsulated water-soluble organic liquid or water-soluble liquid solution is contained in a water permeable receptacle.

28. The method of claim 26 wherein the porous sol-gel material encapsulated water-soluble organic liquid or water-soluble liquid solution is released by applying heat or a vacuum under conditions sufficient to release the porous sol-gel material encapsulated water-soluble organic liquid or water-soluble liquid solution from the porous sol-gel material.

29. The method of claim 26 wherein the porous sol-gel material encapsulated water-soluble organic liquid or water-soluble liquid solution is released by applying sufficient centrifugal force to release the porous sol-gel material encapsulated water-soluble organic liquid or water-soluble liquid solution from the porous sol-gel material.

30. The method of claim 27 wherein the porous sol-gel material encapsulated water-soluble organic liquid or water-soluble liquid solution is released by extracting with water or an aqueous solution under conditions sufficient to release the porous sol-gel material encapsulated from the porous sol-gel material.

31. The method of claim 26 wherein the sol-gel material has a pore volume of from about 0.9 mL/g to about 1.1 mL/g.

32. The method of claim 31 wherein the sol-gel material has a pore volume of from about 0.2 mL/g to about 0.6 mL/g.

33. The method of claim 26 wherein the sol-gel material has a surface area of from about 300 m²/g to about 1300 m²/g.

34. The method of claim 33 wherein the sol-gel material has a pore volume of from about 600 m²/g to about 1000 m²/g.

35. The method of claim 26 wherein the sol-gel material is swellable to at least five times its original volume in acetone.

36. The method of claim 35 wherein the sol-gel is swellable to about eight to ten times its original volume in acetone.

37. The method of claim 26 wherein the porous sol-gel material is obtained from
(a) from about 100 vol. % to about 10 vol. % at least one first alkoxysilane precursor having the formula:
(R′O)₃-Si—(CH₂)ₙ-Ar—(CH₂)ₘ-Si—(OR′)₃ (1)
where n and m are individually an integer from 1 to 8, Ar is a single-, fused-, or poly-aromatic ring, and each R′ is independently a C₁ to C₅ alkyl group and
(b) from about 0 vol. % to about 80 vol. % of at least one second precursor having the formula: 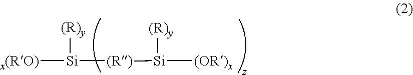
where x is 1, 2, 3 or 4; y is 0, 1, 2, 3; z is 0, 1; the total of x+y+z is 4; each R is independently an organic functional group; each an R′ is independently a C₁ to C₅ alkyl group and R″ is an organic bridging group.

38. The method of claim 37 where x is 2 or 3, y is 1 or 2 and z is 0, R′ is a methyl, an ethyl, or a propyl group.

39. The method of claim 37 wherein R comprises an unsubstituted or substituted straight-chain hydrocarbon group, branched-chain hydrocarbon group, cyclic hydrocarbon group, or aromatic hydrocarbon group.

40. The method of claim 39 wherein R comprises an alkyl hydrocarbon group, an aromatic hydrocarbon group, or an aromatic hydrocarbon group substituted with heteroatom containing moieties or aromatic amines.

41. The method of claim 37 wherein the first alkoxysilane precursor comprises a bis(trialkoxysilylalkyl)benzene.

42. The method of claim 41 where the first alkoxysilane precursor comprises bis 1,4-bis(trimethoxysilylmethyl)benzene (BTB), bis(triethoxysilylethyl)benzene (BTEB), or mixtures thereof.

43. The method of claim 37 wherein the second alkoxysilane precursor comprises tetramethoxysilane, methyltrimethoxysilane, methyltriethoxysilane, dimethyldimethoxysilane, dimethyldiethoxysilane, phenyltrimethoxysiliane, aminopropyl-trimethoxysilane, 1,4-bis(triethoxysilyl)benzene, 2-(trimethoxysilylethyl)pyridine, bis(triethoxysilylpropyl)amine, para-trifluoromethylterafluorophenyltrimethoxysilane, (tridecafluoro-1,1,2,2-tetrahydro-octyl)trimethoxysilane, 3-aminopropyltrimethoxysilane, 3-mercaptopropyltrimethoxysilane, 3-cyanopropyltrimethoxysilane, 3-sulfoxypropyltrimethoxysilane, isocyanopropyltrimethoxysilane, 2-(3,4-epoxycyclohexyl)ethyltrimethoxysilane, isocyanopropyltrimethoxysilane and or trimethoxypropylbenzylcarbamate.

44. The method of claim 26 wherein the amount of water-soluble organic liquid encapsulated by the porous sol-gel material is from about 150 to about 1100% w/w.

45. The method of claim 44 wherein the amount of water-soluble organic liquid encapsulated by the porous sol-gel material is from about 250 to about 950% w/w.

46. The method of claim 45 wherein the amount of water-soluble organic liquid or water soluble liquid solution encapsulated by the porous sol-gel material is from about 400 to about 700% w/w.

47. The method of claim 26 wherein the water-soluble organic liquid or water soluble liquid solution further comprises a solute.

48. The method of claim 47 wherein the solute is a flavor, fragrance or colorant.

49. The method of claim 47 wherein the solute is soluble in water at a concentration of at least 25 grams per liter.

50. The method of claim 49 wherein the solute is soluble in water at a concentration of at least 50 grams per liter.

51. The method of claim 50 wherein the solute is soluble in water at a concentration of at least 100 grams per liter.

52. The method of claim 26 wherein the water-soluble organic liquid is ethanol.

53. The method of claim 52 further comprising a solute.
